(19) United States
(12) Patent Application Publication
(10) Pub. No.: US 2005/0079739 A1
(43) Pub. Date: Apr. 14, 2005

(54) Housing part of a domestic appliance

(75) Inventor: Edmund Illerhaus, Bergatreute (DE)

Correspondence Address: LERNER AND GREENBERG, PA, P O BOX 2480, HOLLYWOOD, FL, 33022-2480, US

(73) Assignee: Diehl AKO Stiftung & Co. KG

(21) Appl. No.: 10/956,676

(22) Filed: Oct. 1, 2004

(30) Foreign Application Priority Data
Oct. 10, 2003 (DE) 103 47 808.6

(51) Int. Cl. H01R 41/00

(52) U.S. Cl. 439/33

(57) ABSTRACT

A housing part for a domestic appliance, preferably a dishwasher, a refrigerator, a freezer, a washing machine or a laundry dryer is uniquely constructed. The housing part has a load-bearing component part formed of an expanded thermosetting plastic, in particular of polyurethane integral foam. In particular, the housing part forms a door or a cover of a domestic appliance.

### BACKGROUND OF THE INVENTION

Field of the Invention

The invention relates to a housing part of a domestic appliance and also to a housing for a domestic appliance with such a housing part and to a domestic appliance with such a housing.

Housing parts of domestic appliances, such as the door of a dishwasher for example, are assembled from a large number of different parts, some of quite different materials, in a complex way. They have an outer shell made of sheet metal and an inner shell made of stainless steel or thermoplastic (i.e. cast) material (for example polypropylene), a nonwoven insulating mat for thermal insulation, a bitumen mat for sound or vibration insulation and a metal structure for the fastening of hinges. All these parts must be assembled predominantly by screwing to the finished dishwasher door. This complex assembly is time and cost-intensive. Furthermore, an extensive inventory and related storage is required for the many different parts.

### SUMMARY OF THE INVENTION

It is accordingly an object of the invention to provide a housing part of a domestic appliance which overcomes the above-mentioned disadvantages of the prior art devices of this general type, which is more simply constructed and easier to assemble housing part for a domestic appliance.

With the foregoing and other objects in view there is provided, in accordance with the invention, a housing part of a domestic appliance. The housing is a load-bearing component part formed of an expanded thermosetting plastic.

By producing a preferably load-bearing component part of the housing part from expanded thermosetting plastic, such as polyurethane foam for example, the effect is achieved that significantly fewer different parts are required for the housing part of the domestic appliance. On account of the high heat, sound and vibration insulating values of the thermosetting plastic, no insulating or other inserted mats have to be installed and, because of the great stability of the thermosetting plastic, no reinforcements have to be installed either.

In a preferred embodiment of the invention, the housing part is a door or a cover of the domestic appliance.

A lock, hinges or connecting, fastening or reinforcing elements may be at least partly enclosed in the plastic foam. Furthermore, screw threads, cable ducts, air tubes, condensed-water tubes or moldings for fastening further component parts of the housing part may be formed in the plastic part.

In a development of the invention, it is provided that operating, indicating and/or controlling elements of the domestic appliance are attached to the plastic part or are fully or partly enclosed in the plastic foam. The operating element may constitute a membrane keyboard, the indicating element may constitute displays or individual light-emitting diodes and the controlling element may constitute preferably encapsulated control electronics.

The entire housing part is preferably assembled from the thermosetting plastic part and one or more further component parts. In this case, the further component part of the housing part may be a plastic shell, which preferably is formed of a thermoplastic material, or a metal shell, which preferably is formed of stainless steel.

Other features which are considered as characteristic for the invention are set forth in the appended claims.

Although the invention is illustrated and described herein as embodied in a housing part of a domestic appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective, exploded view of a door of a dishwasher according to the prior art; and

FIG. 2 is a diagrammatic, perspective, exploded view of a dishwasher door according to the invention.

### DESCRIPTION OF THE PREFERRED EMBODIMENTS

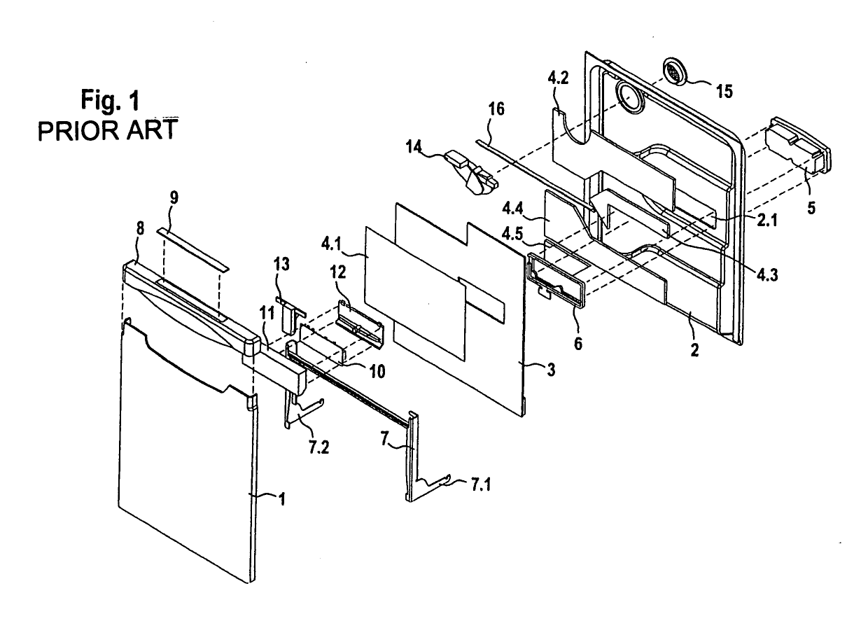

Referring now to the figures of the drawing in detail and first, particularly, to FIG. 1 thereof, there is shown a conventional dishwasher door. The door has an outer sheet-metal shell 1 and an inner plastic or stainless-steel shell 2. In between there is a nonwoven insulating mat 3 and also bitumen mats 4.1 to 4.5. A detergent container 5 is fastened in an opening 2.1 in the inner shell 2 by a holding frame 6, which is screwed against the inner shell 2 from the other side of the latter. To reinforce the outer sheet-metal shell 1 and for the fastening of hinges 7.1 and 7.2, a metal framework 7 is screwed on the outer shell 1. On the outer shell 1 there is an operating and indicating part 8, on which a membrane keyboard 9 is fastened. Control electronics 10 are accommodated in a plastic housing 11 with a cover 12 and fastened to the outer shell 1. Likewise accommodated in the dishwasher door is a lock 13 and also a fan component 14 with an integrated fan and air duct. The fan outlet is provided with a filter covering cap 15. To reinforce the door structure, a metal bar 16 is also screwed to the inner shell 2.

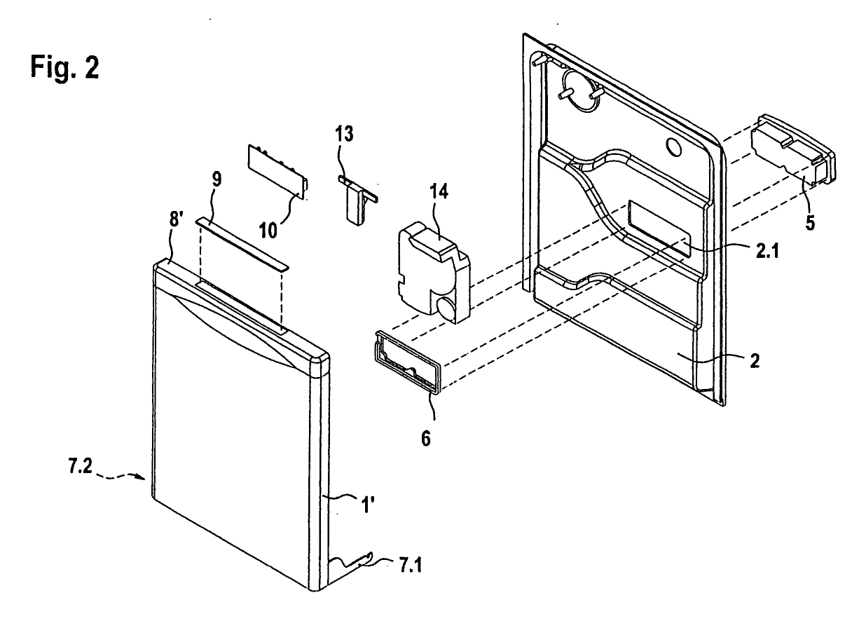

In comparison to this, the construction of a refrigerator door according to the invention is significantly simpler and is shown in FIG. 2. The outer sheet-metal shell is replaced by a plastic part 1′ formed of an expanded thermosetting plastic. The operating and indicating part 8′ is integrated in the plastic part 1′, i.e. is made in one piece with the latter. The hinges 7.1 and 7.2 are partly enclosed in the plastic foam of the plastic part 1′ and are consequently already firmly connected to the latter. The (welded-in or else not welded-in) control electronics 10 may be placed in the plastic part 1′, adhesively cemented in or even enclosed by the foam—without first having to be accommodated in a housing of their own.

As can easily be seen from a comparison of FIGS. 1 and 2, according to the invention there is no need for a large number of individual parts, and the assembly of the dishwasher door is also significantly simplified.

The plastic part 1′ is produced by a polyurethane integral foam technique. As a thermosetting plastic, PU foam has a series of advantages: high pressure, as used for example in the casting of thermoplastic material, is not required during production. Consequently, the molds required are simpler to produce and cheaper, thereby also making small production runs possible, and consequently different housing fronts or forms for different types of appliance. In addition, PU foam is flame retardant (it only burns above 500° C.) and has high insulating and damping values with respect to heat, sound and vibration. The relatively high wall thickness of plastic parts made of PU foam mean that they have great stability and do not need to be additionally reinforced by stabilizing elements being inserted or enclosed in the foam—although this is quite possible. Coloring of the plastic part 1′ and equally variation of the degree of hardening of the material or the surface are possible. Furthermore, if plastic is used, there is a greater freedom of design, so that contours, air tubes and condensed-water tubes as well as cable ducts can be designed according to requirements. Furthermore, operating, indicating and controlling elements can be integrated by attaching them to or else at least partly enclosing them in the foam of the plastic part 1′.

The integral foam technique allows the front side of the plastic part 1′ already to be given such a pleasant appearance that there is no longer any need for the door to be provided with a facing or veneer. In spite of this, if the corresponding domestic appliance is for example integrated in a row of kitchen units with the same fronts, a corresponding facing can be provided on the front side of the plastic part 1′.

The invention is not restricted to the exemplary embodiment described. For example, it can also be used in the case of doors or covers of refrigerators and deep freezers or chest freezers. Furthermore, all other housing parts of domestic appliances can also be formed on the basis of this invention.

This application claims the priority, under 35 U.S.C. § 119, of German patent application No. 103 47 808.6, filed Oct. 10, 2003; the entire disclosure of the prior application is herewith incorporated by reference.

1. A housing part of a domestic appliance, comprising:
a load-bearing component part formed of an expanded thermosetting plastic.

2. The housing part according to claim 1, wherein said load-bearing component part being part of a door or a cover of the domestic appliance.

3. The housing part according to claim 1, further comprising:
a lock;
hinges; and
elements for connecting, fastening, and/or reinforcing, said lock, said hinges and said elements are at least partly enclosed in said expanded thermosetting plastic.

4. The housing part according to claim 1, wherein said load-bearing component part has at least one of screw threads, cable ducts, air tubes, condensed-water tubes and moldings for fastening further component parts, formed therein.

5. The housing part according to claim 1, further comprising elements selected from the group consisting of operating elements, indicating elements and controlling elements, said elements are one of attached to said load-bearing plastic part, fully enclosed in said load-bearing plastic part, and partly enclosed in said load-bearing plastic part.

6. The housing part according to claim 5, wherein said operating element is formed by a membrane keyboard, said indicating element is selected from the group consisting of displays and light-emitting diodes, and said controlling element is an encapsulated control electronic unit.

7. The housing part according to claim 1, further comprising at least one further component part attached to said load-bearing component part for forming the housing part.

8. The housing part according to claim 7, wherein said further component part is a plastic shell.

9. The housing part according to claim 8, wherein said plastic shell is formed of a thermoplastic material.

10. The housing part according to claim 7, wherein said further component part is a metal shell.

11. The housing part according to claim 10, wherein said metal shell is formed from stainless steel.

12. The housing part according to claim 10, wherein said expanded thermosetting plastic is polyurethane foam.

13. The housing part according to claim 10, wherein the domestic appliance is selected from the group consisting of a dishwasher, a refrigerator, a freezer, a washing machine and a laundry dryer.

14. A housing for a domestic appliance, comprising:
a housing part having a load-bearing component part formed of an expanded thermosetting plastic.

15. A domestic appliance, comprising:
a housing having a housing part with a load-bearing component part formed of an expanded thermosetting plastic.
